(19) United States
(12) Patent Application Publication
(10) Pub. No.: US 2016/0097667 A1
(43) Pub. Date: Apr. 7, 2016

(54) FLUID MONITORING ASSEMBLY

(71) Applicant: Christos Zavolas, Elizabeth, NJ (US)

(72) Inventor: Christos Zavolas, Elizabeth, NJ (US)

(21) Appl. No.: 14/504,803

(22) Filed: Oct. 2, 2014

(51) Int. Cl. G01F 15/06

(52) U.S. Cl. CPC G01F 15/068

(57) ABSTRACT

A fluid monitoring assembly includes a base housing fluidly coupled between a fluid source and a fluid supply. A sensor is coupled to the base housing to detect a rate and a duration of a flow of a fluid through the base housing. A remote housing is removably coupled to the base housing. A processor is coupled to the remote housing. The sensor notifies the processor of an unexpected rate or duration of the flow of the fluid. A transceiver is coupled to the remote housing and the processor. The transceiver is in electromagnetic communication with the internet to notify a user of the unexpected rate or duration of the flow of the fluid. An alarm is coupled to the remote housing. The alarm is electrically coupled to the processor to emit an audible alarm corresponding with the unexpected rate or duration of the flow of the fluid.

### BACKGROUND OF THE DISCLOSURE

### Field of the Disclosure

The disclosure relates to monitoring devices and more particularly pertains to a new monitoring device for alerting a user to an unexpected flow of a fluid.

### SUMMARY OF THE DISCLOSURE

An embodiment of the disclosure meets the needs presented above by generally comprising a base housing fluidly coupled between a fluid source and a fluid supply. A sensor is coupled to the base housing to detect a rate and a duration of a flow of a fluid through the base housing. A remote housing is removably coupled to the base housing. A processor is coupled to the remote housing. The processor is electrically coupled to the sensor when the remote housing is coupled to the base housing. Thus, the sensor notifies the processor of an unexpected rate or duration of the flow of the fluid. A transceiver is coupled to the remote housing. The transceiver is electrically coupled to the processor. The transceiver is in electromagnetic communication with the internet to notify a user of the unexpected rate or duration of the flow of the fluid. An alarm is coupled to the remote housing. The alarm is electrically coupled to the processor to emit an audible alarm corresponding with the unexpected rate or duration of the flow of the fluid.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF THE DRAWINGS

The disclosure will be better understood and objects other than those set forth above will become apparent when consideration is given to the following detailed description thereof. Such description makes reference to the annexed drawings wherein:

FIG. 1 is a perspective view of a fluid monitoring assembly according to an embodiment of the disclosure.

FIG. 2 is a front view of an embodiment of the disclosure.

FIG. 3 is a schematic view of an embodiment of the disclosure.

### DESCRIPTION OF THE PREFERRED EMBODIMENT

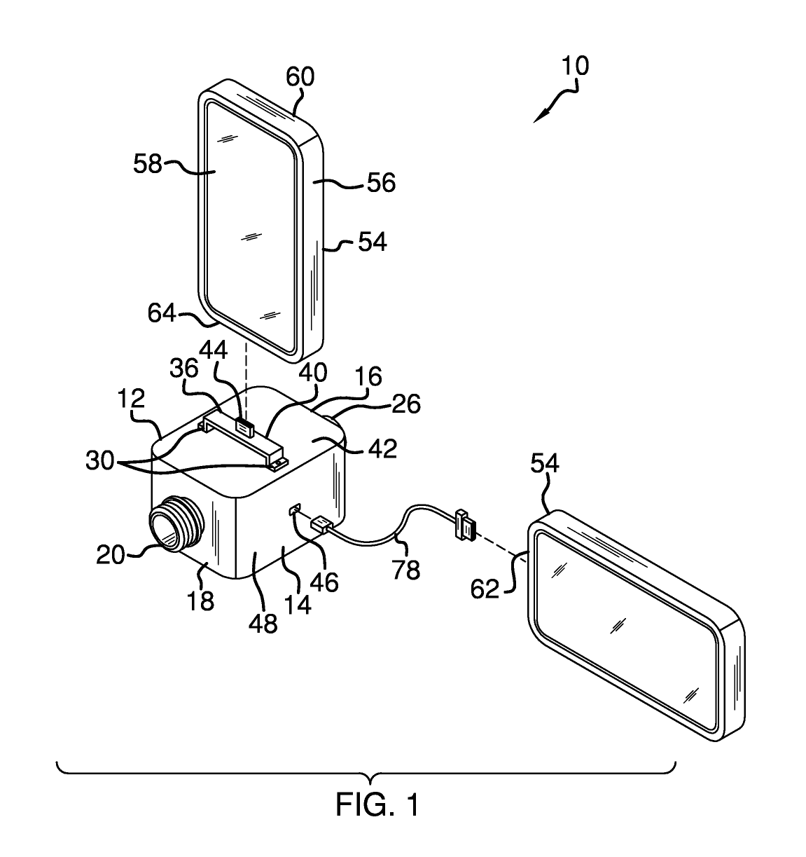

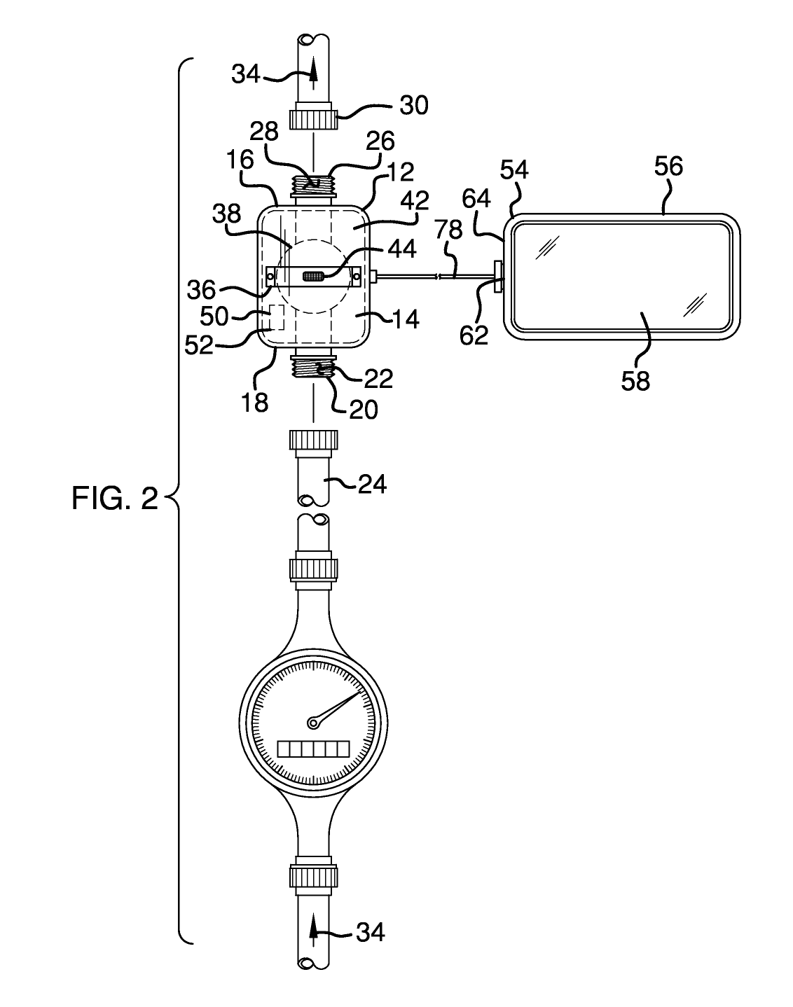

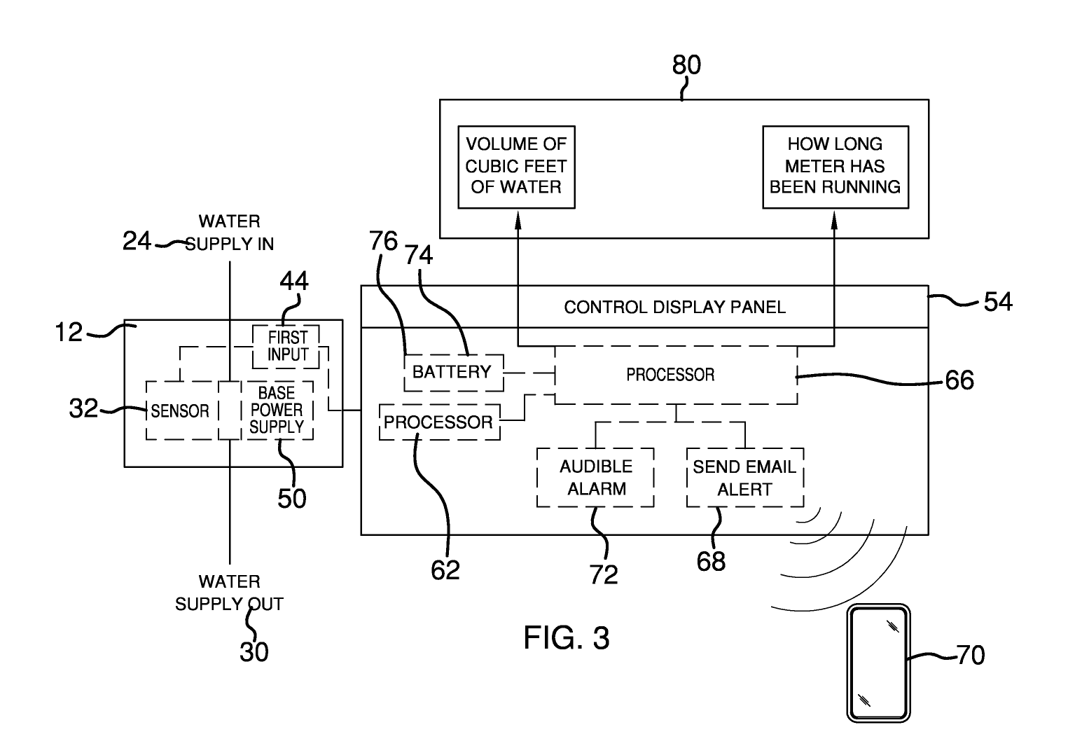

With reference now to the drawings, and in particular to FIGS. 1 through 3 thereof, a new monitoring device embodying the principles and concepts of an embodiment of the disclosure and generally designated by the reference numeral 10 will be described.

As best illustrated in FIGS. 1 through 3, the fluid monitoring assembly 10 generally comprises a base housing 12. The base housing 12 has an outer wall 14 extending between each of a top end 16 and a bottom end 18 of the base housing 12. An inlet 20 is fluidly coupled to the bottom end 18 of the base housing 12. An exterior surface 22 of the inlet 20 is threaded. The inlet 20 threadably engages a fluid source 24 to fluidly couple the inlet 20 to the fluid source 24.

An outlet 26 is fluidly coupled to the top end 16 of the base housing 12. The outlet 26 is in fluid communication with the inlet 20. An outermost surface 28 of the outlet 26 is threaded. The outlet 26 threadably engages a fluid supply 30 to fluidly couple the outlet 26 to the fluid supply 30. The fluid source 24 may be a plumbed water source or the like. The fluid supply 30 may be a plumbed water supply to a building or the like.

A sensor 32 is coupled to the base housing 12. The sensor 32 is fluidly coupled between the inlet 20 and the outlet 26 to detect a rate and a duration of a flow of a fluid 34 through the base housing 12. The fluid 34 may be water. The sensor 32 may be an electronic fluid flow sensor or the like.

A bracket 36 is provided. The bracket 36 has a pair of ends arms 38 each extending away from a central arm 40. Each of the end arms 38 is coupled to a front side 42 of the outer wall 14 of the base housing 12. A first input 44 is coupled to the central arm 40. The first input 44 is electrically coupled to the sensor 32. A secondary first input 46 is coupled to a first lateral side 48 of the outer wall 14. The secondary first input 46 is electrically coupled to the sensor 32. Each of the first input 44 and the secondary first input 46 may be an electrical port or the like.

A base power supply 50 is coupled to the base housing 12. The base power supply 50 is electrically coupled to the sensor 32. The base power supply 50 comprises at least one battery 52.

A remote housing 54 is provided. The remote housing 54 has an exterior edge 56 extending between each of a front side 58 and a back side 60 of the remote housing 54. A second input 62 is coupled to a lower side 64 of the exterior edge 56. The second input 62 may be an electrical port or the like. The second input 62 engages the first input 44 such that the first input 44 is in electrical communication with the second input 62 and the remote housing 54 is removably coupled to the base housing 12.

A processor 66 is coupled to the remote housing 54. The processor 66 is electrically coupled to the second input 62. The processor 66 is in electrical communication with the sensor 32 when the remote housing 54 is coupled to the base housing 12. Thus, the sensor 32 notifies the processor 66 of an unexpected rate or duration of the flow of the fluid 34.

A transceiver 68 is coupled to the remote housing 54. The transceiver 68 is electrically coupled to the processor 66. The transceiver 68 is in electromagnetic communication with the internet through wireless networking, hardwiring or the like to notify a user 70 of the unexpected rate or duration of the flow of the fluid 34. Thus, the processor 66 may issue an email or a text message or other similar electronic message to the user 70. The transceiver 68 may be an RF transceiver or the like.

An alarm 72 is coupled to the remote housing 54. The alarm 72 is electrically coupled to the processor 66 to emit an audible alarm corresponding with the unexpected rate or duration of the flow of the fluid 34. A remote power supply 74 is coupled to the remote housing 54. The remote power supply 74 is electrically coupled to the processor 66. Moreover, the remote power supply 74 comprises at least one battery 76.

A data cord 78 is provided. The data cord 78 may be electrically coupled between the second input 62 and the secondary first input 46 so the processor 66 is in electrical communication with the sensor 32. The data cord 78 is used in lieu of the first input 44.

In use, the remote housing 54 is electrically coupled to an external electronic device 80 to receive data relating to an acceptable rate and duration of the flow of the fluid 34. Additionally, the preferred method of communication between the transceiver 68 and the user 70 is defined. The assembly 10 allows the user 70 to be immediately notified of a potential fluid leak or other similar detrimental situation relating to the fluid supply 30.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A fluid monitoring assembly comprising:
a base housing configured to be fluidly coupled between a fluid source and a fluid supply;
a sensor coupled to said base housing such that said sensor is configured to detect a rate and a duration of a flow of a fluid through said base housing;
a remote housing removably coupled to said base housing;
a processor coupled to said remote housing, said processor being electrically coupled to said sensor when said remote housing is coupled to said base housing wherein said sensor notifies said processor of an unexpected rate or duration of the flow of the fluid;
a transceiver coupled to said remote housing, said transceiver being electrically coupled to said processor, said transceiver being in electromagnetic communication with the internet wherein said transceiver notifies a user of the unexpected rate or duration of the flow of the fluid; and
an alarm coupled to said remote housing, said alarm being electrically coupled to said processor wherein said alarm emits an audible alarm corresponding with the unexpected rate or duration of the flow of the fluid.

2. The assembly according to claim 1, wherein:
said base housing having an outer wall extending between each of a top end and a bottom end of said base housing;
an inlet fluidly coupled to said bottom end of said base housing, said inlet being fluidly coupled to the fluid source;
an outlet fluidly coupled to said top end of said base housing such that said outlet is in fluid communication with said inlet, said outlet being fluidly coupled to the fluid supply; and
said sensor being fluidly coupled between said inlet and said outlet.

3. The assembly according to claim 2, further comprising:
a bracket coupled to a front side of said outer wall; and
a first input coupled to said bracket, said first input being electrically coupled to said sensor.

4. The assembly according to claim 3, wherein:
said remote housing having an exterior edge extending between each of a front side and a back side of said remote housing; and
a second input coupled to a lower side of said exterior edge, said second input engaging said first input such that said first input is in electrical communication with said second input and said remote housing is retained on said base housing, said second input being electrically coupled to said processor.

5. The assembly according to claim 1, further comprising a base power supply coupled to said base housing, said base power supply being electrically coupled to said sensor, said base power supply comprising at least one battery.

6. The assembly according to claim 1, further comprising a remote power supply coupled to said remote housing, said remote power supply being electrically coupled to said processor, said remote power supply comprising at least one battery.

7. A fluid monitoring assembly comprising:
a base housing, said base housing having an outer wall extending between each of a top end and a bottom end of said base housing;
an inlet fluidly coupled to said bottom end of said base housing, said inlet being fluidly coupled to a fluid source;
an outlet fluidly coupled to said top end of said base housing such that said outlet is in fluid communication with said inlet, said outlet being fluidly coupled to a fluid supply;
a sensor coupled to said base housing, said sensor being fluidly coupled between said inlet and said outlet such that said sensor is configured to detect a rate and a duration of a flow of a fluid through said base housing;
a bracket coupled to a front side of said outer wall;
a first input coupled to said bracket, said first input being electrically coupled to said sensor;
a base power supply coupled to said base housing, said base power supply being electrically coupled to said sensor, said base power supply comprising at least one battery;
a remote housing, said remote housing having an exterior edge extending between each of a front side and a back side of said remote housing;
a second input coupled to a lower side of said exterior edge, said second input engaging said first input such that said first input is in electrical communication with said second input and said remote housing is removably coupled to said base housing;
a processor coupled to said remote housing, said processor being electrically coupled to said second input, said processor being in electrical communication with said sensor when said remote housing is coupled to said base housing wherein said sensor notifies said processor of an unexpected rate or duration of the flow of the fluid;
a transceiver coupled to said remote housing, said transceiver being electrically coupled to said processor, said transceiver being in electromagnetic communication with the internet wherein said transceiver notifies a user of the unexpected rate or duration of the flow of the fluid;
an alarm coupled to said remote housing, said alarm being electrically coupled to said processor wherein said alarm emits an audible alarm corresponding with the unexpected rate or duration of the flow of the fluid; and
a remote power supply coupled to said remote housing, said remote power supply being electrically coupled to said processor, said remote power supply comprising at least one battery.
